(19) United States
(12) Patent Application Publication
(10) Pub. No.: US 2005/0071689 A1
(43) Pub. Date: Mar. 31, 2005

(54) Independently powered slots architecture and method

(75) Inventors: Michael Hamilton Coward, San Diego, CA (US); Alan Michael Signorelli, La Costa, CA (US); Jeffrey Vanderbilt Schafer, Carlsbad, CA (US); David Albert French, Carlsbad, CA (US); Bryan C. Gurganus, Raleigh, NC (US)

Correspondence Address: MORGAN LEWIS & BOCKIUS LLP, 1111 PENNSYLVANIA AVENUE NW, WASHINGTON, DC, 20004, US

(73) Assignee: Continuous Computing Corporation

(21) Appl. No.: 10/671,432

(22) Filed: Sep. 26, 2003

(51) Int. Cl. G06F 1/26

(52) U.S. Cl. 713/300

(57) ABSTRACT

An independently powered slots architecture for use in telecom/datacom systems, the architecture including the capability to support at least one power module, and may include a manager module, a storage module, an alarm module, a console module, and a cooling module. Method for using same also disclosed.

### BACKGROUND OF THE INVENTION

1. Field of the Invention

The present invention relates to supplying power in telecom/datacom systems; more particularly, the present invention relates to a modular power architecture and method which maximizes reliability and scalability in these systems.

2. Description of the Related Art

Today's card-based telecom systems use two kinds of power distribution: centralized and distributed. Centralized power supply configurations use one or more power supplies with power from these supplies distributed across a shared power bus to all cards in the system. This shared bus represents a single point of failure. There is no possibility of isolating this fault because the power bus powers all of the cards in the system. Therefore, a failure of this bus results in a failure of the entire system. Further deficiencies in these systems revolve around the centralized nature of these power configurations, requiring the budgeting of power among the serviced cards and incurring enormous expense should replacing the centralized systems become necessary.

Distributed power systems are also present in the market. In these systems, each card has a separate power supply integrated onto the card, which eliminates the single point of failure concerns in the centralized power supply architecture. However, distributed power architecture cards have historically been much more expensive than cards designed for use in a centralized power architecture. Further, converting a system or cards from a centralized power distribution architecture to a distributed power distribution architecture has historically required a complete redesign of the system and the cards, with no way to use centralized cards in a distributed architecture.

### SUMMARY OF THE INVENTION

Accordingly, the present invention is directed to providing a distributed power architecture that can overcome the limitations and disadvantages of the related art, allowing the use of cards from centralized power systems while maintaining the advantages of distributed power.

An object of the present invention is to provide a platform with innovative power architecture that maximizes reliability and scalability.

Another object of the present invention is to provide an architecture that removes shared powered buses as a single point of failure.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the system includes a method of providing power to a telecom/datacom system, the system having a plurality of slots for housing a plurality of types of electronic circuit boards and power supply, the method comprising forming independently powered slots by coupling each slot adapted to receive a power supply to a different slot adapted to receive any of a plurality of types of electronic circuit boards, housing at least one power supply in a slot adapted to receive a power supply; housing at least one electronic circuit board of the plurality of types in a slot coupled to a slot housing the at least one power supply, and supplying power to the electronic circuit board of the plurality of types from the power supply via the coupled slots.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a front view of a chassis used in implementing an embodiment of the present invention;

FIG. 2 is a rear view of a chassis used in implementing an embodiment of the present invention;

FIG. 3 is front view of the chassis layout in an embodiment of the present invention;

FIG. 4 is a side view of the internals of the chassis in an embodiment the present invention.

FIG. 5 is a front view of a power module used in accordance with an embodiment of the present invention;

FIG. 6 is a front view of an LED panel used in accordance with an embodiment of the present invention; and,

FIG. 7 is a front view of an alarm module used in accordance with an embodiment of the present invention.

### DETAILED DESCRIPTION OF THE VARIOUS EMBODIMENTS

The present invention, finding application in a variety of telecom/datacom systems, solves the deficiencies of the traditional power platforms. For example, in one embodiment, these deficiencies are solved by powering each card slot by a small efficient and inexpensive power supply inserted above the standard 6U card cage. The power supply may be a hot swappable card plugged into the midplane to provide power to the standard card in the single slot directly below it. Each slot is thus independently powered and each power supply card can provide about 70-100 watts. Moreover, since each slot is independent, power cards are only needed for those slots that are actually being used.

To further improve high availability, other embodiments may also have dual power input connections from a central office power distribution unit for each of redundant power feeds, with redundant power input trays supporting connections to both power feeds to allow either power input tray to support full distribution to the entire system. Further, each platform may feature redundant, replaceable modules for all vital platform elements, including, for example, management cards, fan trays, power inputs, and switches. These power systems may also include manager modules located, for example, about each fabric slot; these manager modules may be hot-swappable, and may provide, for example, redundant modular, unified chassis and system level management capabilities and/or power to various system elements (e.g., switches).

Reference will now be made in detail to various embodiments of the present invention, examples of which are illustrated in the accompanying drawings.

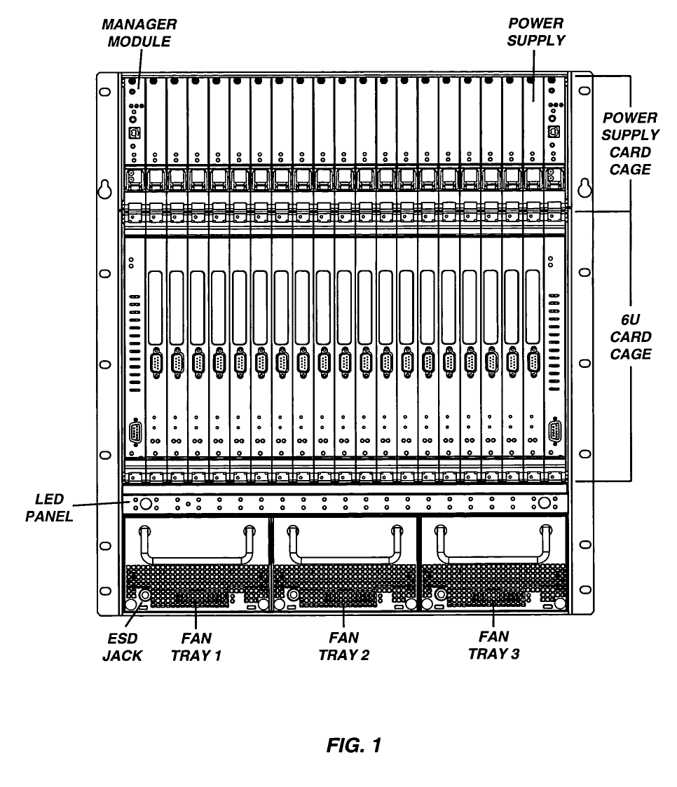

FIG. 1 is a front view of a chassis used in implementing one embodiment of the present invention. In this embodiment, the chassis may have a height of approximately 13Us or 22.75 inches. The chassis may be further designed for mounting in a 19 inch wide frame, 23 inch telecommunications racks and cabinets and ETSI (European Telecommunication Standards Institute) and 24 inch EIA (Electronics Industries Association) . The chassis may also support front and center mounting, i.e., mounting ears may either be attached to the front or center of the chassis side panels for mounting in telecommunications rack or cabinet. The chassis depth may be approximately the standard compact chassis. As illustrated in FIG. 1, this embodiment may include a 21-slot, 6U main card cage and a 21-slot, 3U power card cage. The power card cage may be located above the 6U main card cage; otherwise, if the power card cage is beneath the main card cage, airflow could be heated by the power cards before reaching the 6U blades. Improved card guides may be used in all card cages to prevent bending pins. The chassis may further support a replaceable airflow filter tray. The airflow filter tray may be located beneath and adjacent to the 6U main card cage and may be placed adjacent to the card cage to minimize pressure drop. The chassis may also support three hot-swappable fan trays. The fan trays may be arranged side-by-side with each being approximately one third the width of the card cage. The fan trays may be located directly above the air inlet. The chassis may provide sufficient space between the fan tray modules and the airflow filter tray. The chassis may also provide front-to-back airflow and an air inlet may be placed at the bottom, front of the chassis. The chassis may further support a front LED panel, and the LED panel may be located beneath the 6U main card cage, beneath the airflow filter tray, or may be in front of the airflow space. The chassis may further provide a front electrostatic discharge (“ESD”) jack, which in turn may use a banana connector with a metallic shroud, and the jack may be labeled “ESD.”

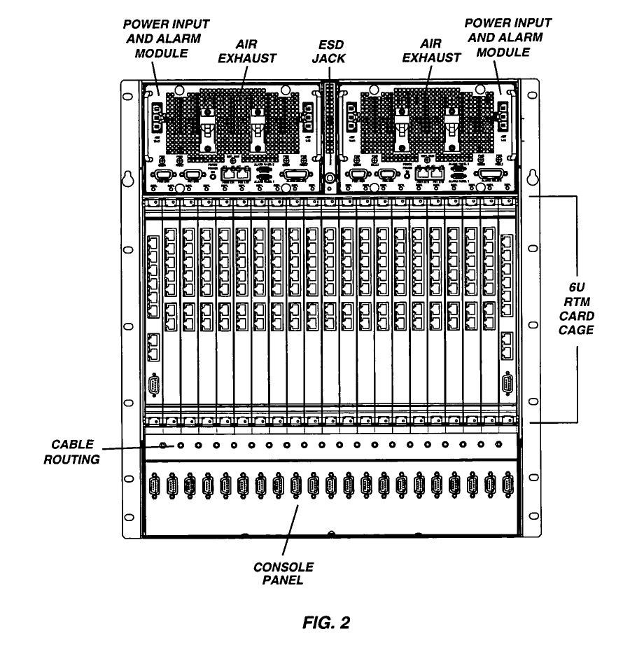

FIG. 2 is a rear view of a chassis used in implementing one embodiment of the present invention. The rear of the chassis may include a 21-slot, 6U rear transition card cage. The rear transition card cage may be located directly behind the front 6U main card cage. An air exhaust may be located at the top rear of the chassis. The chassis may support redundant, replaceable flex alarm modules, such as an integrated power input tray, rear manager I/O, alarm panel, and LED panel. The alarm module may not impede airflow, and may be located above the rear transition card cage. This is done in order to minimize the routing of power to the power cards and because the cards may not fit at the bottom due to the size of dual-fan tray. The chassis may also support a console panel which may provide slot numbers and serial connections for each slot. The console panel may be located below the rear transition card cage in order to minimize the length of serial cables between rear transition cards and the console panel. The chassis may further have a single slot ESD panel located in a slot between the alarm modules. The chassis may also provide a cable management tray near the bottom rear of the chassis, which may be located just above the power input trays. The cable management tray may be located so as not to impede access to any connectors. This may be done, for example, by providing a tray which is hinged so that it can be easily moved out of the way as needed. The chassis may also provide a cable management feature for the power input/alarm modules.

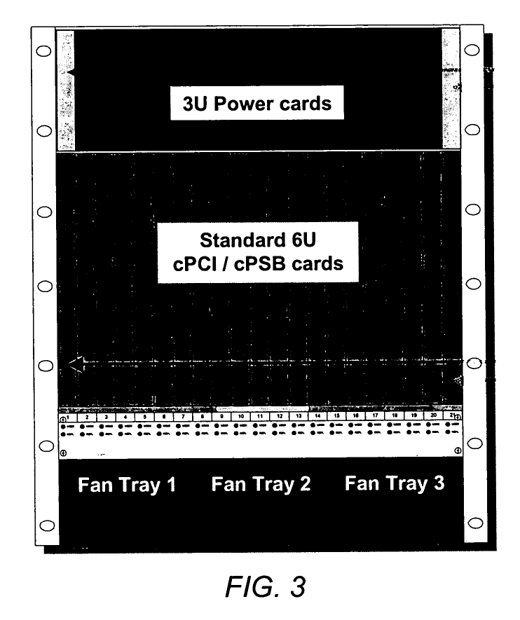

FIG. 3 is front view of the chassis layout according to another embodiment of the present invention. As illustrated in FIG. 3, the midplane section of this embodiment may extend to the power card cage as well as the 6U card cage to allow interconnection between power cards 6U cards. Furthermore, the midplane may extend as high as necessary to support power card cage connectors so that it does not impede airflow. The two fabric slots for the 6U card cage may be the far left and far right slots on the midplane with the 19 node slots located between these two fabric slots. The two manager slots for the power card cage may be located directly above the 6U fabric slots. The midplane may support compact PCI midplane keying and front panel keying. The midplane may provide radial IPMI (Intelligent Platform Management Interface) bus connections between manager slots and each power slot. The midplane may route the manager I/O connector signals through the rear to support rear connectors in addition to the ones located on each manager front panel. The midplane may connect appropriate pins from the power card cage slot connector to, for example, compact PCI power pins on J1 & J2 of the slot beneath it. The midplane may further support PICMG 2.16. The midplane may also provide jumpers for each slot to enable/disable PICMG 2.16, thus allowing support for non-CompactPCI Packet Switched Backplanes (“cPSB”) cards that would otherwise have a conflict with the cPSB pins on J3. The 2.16 enable/disable jumpers may default to 2.16 enabled on all slots. The midplane may support the ability for management software to detect each slot's 2.16 enable/disable setting. The midplane may also support H.110 on all 2.16 node slots and appropriate creepage and clearance for H.110. The midplane may support PCI modules on all node slots, i.e., feed-through pins may be used on J1 and J2. Furthermore, all node slots on the midplane may support Store modules, and the midplane may route serial between the console and power/manager modules for each slot.

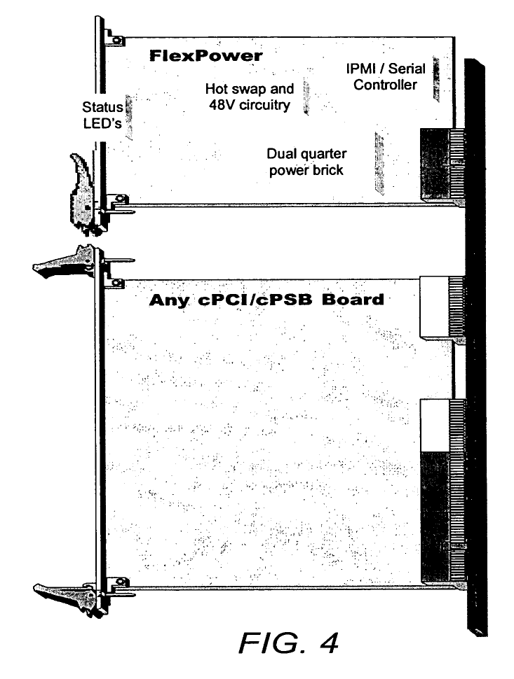

FIG. 4 is a side view of the chassis, according to another embodiment of the present invention. In this embodiment, power to each node slot is provided by the power module located in the power card cage above the node slot. The power module may provide power to the 6U slot directly beneath it via the midplane, and accordingly to, for example, standard compact PCI pins for the 6U slot. In addition, the power modules may use elongated, flat ejector handles, in order to prevent interference when swapping the 6U card beneath it. The power module may also be an independently hot-swappable module, and the power −48V feeds and returns may be isolated. In addition, the power module may incorporate an IPMI controller and communicate over a dedicated IPMI bus with the manager modules. The power module may support the ability for the manager to monitor and control its power state via IPMI, and may maintain its power state, i.e., on/off. In the event of a power-cycle, the power module may come up in the off state and wait for a command from the manager module before turning on. The power module may also incorporate an Emergency On input from the midplane. When this pin is grounded, the power module may turn on and stay on until commanded by the manager, i.e., latched. This feature may be designed to provide a mechanism that would allow a user to force the system on if all manager modules are missing or failed.

FIG. 5 is a front view of the chassis with an inset illustrating a power module used in accordance with an embodiment of the present invention. The power module may have an indicator for indicating whether power is being supplied by the module or for indicating that a module needs to be replaced. As illustrate in FIG. 5, the power module may be provided with, for example, a green “POWER” LED on the front panel of the power module to indicate that power is being provided to the 6U card below it. The power LED may be horizontally aligned with the power LED on the front panel of the manager module. Further, a red “REPL” LED may be provided on the front panel of the power module to indicate that the module needs to be replaced. The replace LED may be horizontally aligned with the replace LED on the front panel of the manager module. Other indicators will be known to those skilled in the art and are within the scope of the present invention.

Referring back to FIG. 1, in another embodiment of the present invention, the chassis may also include a manager module. Manager modules are management and alarming cards for the platform. The manager module may use the same elongated, flat ejector handles used on the power modules. This may be done with the object of preventing annoying interference when swapping the 6U card beneath it and to provide room for a CLEI (Common Language Equipment Identification) code on the ejector handle. The manager modules may also provide power to the switch (fabric) slot beneath it. The manager modules may also provide radial-drop IPMI connections to all power modules in the chassis. The manager cards provide radial connections but there is only 1 drop connection to each power card. The manager module may also provide I2C connections to each fan tray, alarm module, and LED panel. The manager may have sufficient processing power to accommodate chassis management and system management functionality. Furthermore, indicators may be provided. For example, a green “ACTIVE” LED may be provided to indicate whether the manager module is in active mode. Also green “POWER” LED may be provided on the front panel of the power module to indicate that power is being provided to the 6U card below it. The power LED may be horizontally aligned with the power LED on the front panel of the manager modules. A red “REPL” LED also may be provided on the front panel of the power module to indicate that the module needs to be replaced. The replace LED may be horizontally aligned with the replace LED on the front panel of the manager modules. The failure of both 48V fuses may not prevent the status LEDs from being illuminated. The power module may also support a lamp-test mode for the status LEDs.

Critical, major, and minor alarm LEDs may be supported on the manager front panel. The alarm LED colors may be red for critical, red for major and yellow for minor alarms respectively. The manager may provide a lamp-test mode for alarm LEDs. An alarm clear button may be provided on the manager front panel to support manual clearing of active alarms. The alarm clear button may be labeled “ALARM CLEAR,” or “CLEAR” and the alarm clear button may be recessed. The manager module may also provide a real-time clock to enable time-stamping of events. The real-time clocks on active and standby manager modules may be synchronized. The manager module may also be able to synchronize to an external clock source, thus allowing the user to specify a time-server for clock synchronization. Other alarm indicators will be known to those of skill in the art and are within the scope of the present invention.

In a further embodiment, the chassis may include a storage carrier module. The dimensions of the storage carrier module may be 6U high×8 hp wide (i.e., dual-slot). The storage carrier may be hot-swappable, and support two industry standard 3.5″ SCSI SCA disks. The carrier module may also provide two independent SCSI buses and each disk may be independently hot-swappable. The storage carrier may support the ability to monitor each disk independently. The disks may be flush with the front panel, and if the disks must protrude from the front panel, the protrusion shall be minimal. If disks must protrude from the front panel, protrusion may not interfere with access to connectors (e.g., RJ45s) on adjacent cards. One 80-pin SCA connector may be provided for each disk. Power for each disk may be provided via J1. SCSI signals for each drive may be routed to the midplane via either J3 or J5. Pinout on these signals may conflict with other standards such as H.110 or 2.16. RAID configurations may be supported. Use of the storage carrier in a chassis may impede the ability of the chassis to meet EMI, NEBS (Network Equipment Building System), or other such regulatory requirements. Two 68-pin SCSI (IN and OUT) connectors may be provided on the rear panel for each SCSI bus (i.e., rear I/O connectors for each SCSI but to support additional disks). Each SCSI bus may support external termination, and one SCSI target ID selector may be provided on the rear panel for each disk.

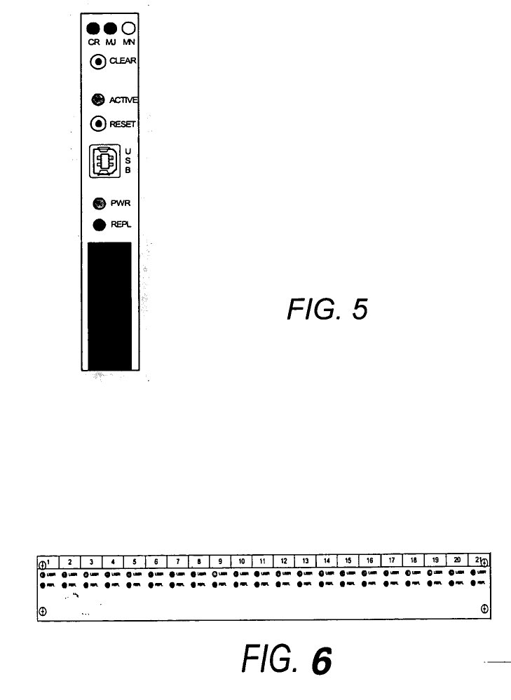

FIG. 6 illustrates an LED panel that may be included on the chassis illustrated for example in FIG. 1. As shown in FIG. 6, the front LED panel may provide a slot number for each main card cage slot. The slot numbering may physically align with the main card cage slots. The front LED panel may be shallow enough to be mounted in front of the plenum space of the chassis without impending airflow, and may be replaceable. The front LED panel may also provide a red/green “USER” to provide a user defined indication associated with the slot. The front LED panel may also provide a red “REPL” LED to indicate whether the card in the slot needs to be replaced. The front LED panel may also support a lamp-test mode for replace and user LEDs and in the lamp-test mode, the user LED may be yellow.

The chassis may also include a cooling module, according to one embodiment of the present invention. The chassis illustrated in FIG. 1, for example, includes three fan trays for redundant cooling. Each fan tray may be an independently hot swappable module. Variable speed fans may be employed to reduce system noise and meet redundancy objectives. The fan tray module or modules may be secured with captive standard/Phillips screw or captive thumbscrew. The fan tray module may be powered from dual 48V feeds and may be fused on each 48V feed. Additionally, the fan tray module may incorporate an IPMI controller. The IPMI controller may be re-programmable over IPMI to allow for bug fixes or new functionality. The fan tray may also support diode inputs. Status LEDs may be provided on the front panel of each fan tray module. A green “POWER” LED may be provided to indicate that the module is receiving power. A red “REPL” LED may be provided to indicate that the module needs to be replaced. The failure of both 48V fuses may not prevent status LEDs from being illuminated, i.e., LEDs get IPMB power. The fan tray module may support a lamp-test mode for status LEDs. The fan tray modules may force vertical airflow across both main and power card cages. A minimum of 300 LFM may be provided over each main card cage slot when a blank load board is installed. Also, a minimum 300 LFM may be provided over each main cage slot when a single fan has failed (rotor locked). A minimum of 150 LFM may be provided over each main card cage slot when a single cooling module has been removed. All airflow measurements may be met to within one inch of the front and back of the slot. Air blockers may be provided for populating unused slots in the power card cage and in the main card cage. Cooling air may be filtered with a filter that meets NEBS requirements. The filter may comply with GR78, R8-4. The filter may be an independently hot-swappable module. Temperature sensors may be provided on each power and manager module to support monitoring of exhaust temperature. Also, temperature sensors may be provided on each fan try module to support monitoring of inlet temperature. A sensor may be provided for monitoring fan performance, i.e., fan speed. The monitoring may be accomplished directly by manager modules or via a local microcontroller that reports status over IPMI. If variable speed fans are being used, failure of the monitoring circuit may cause the fans to run at maximum speed. A sensor may be provided for monitoring filter presence. The manager module may be notified in the event that communication is lost with any cooling sensor.

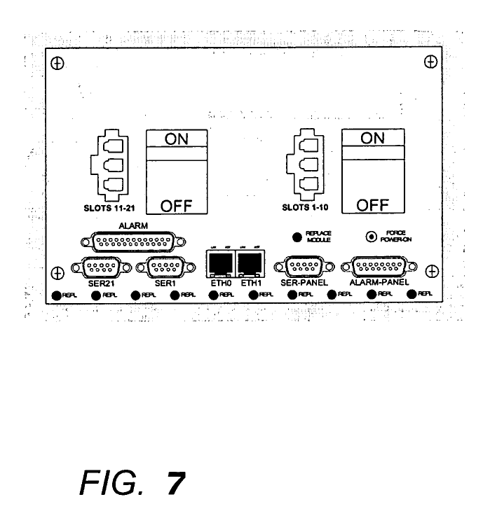

FIG. 7 illustrates an alarm module that may be implemented on the chasis, according to one embodiment of the present invention. For example, the chassis shown in FIG. 1 provides two alarm modules, for redundancy purposes. Thus, either alarm module may be capable of providing power for the entire chassis. Each alarm module may be an independently hot-swappable unit or module, and may support two 48V DC units. Additionally, each alarm module may provide integrated power input filters and may include a circuit breaker that can function as an ON/OFF switch. For a front/rear deployment chassis, the alarm module may be located on the rear of the chassis. Also, the module may not impede front-to-back airflow, and each alarm module may be provided with an emergency “FORCE POWER-ON” button. If neither manager card is working, this button allows the craftsperson to force the chassis to power-on. Even though this is a dual failure scenario, it addresses the question of what happens if you completely loose management capability. The emergency power-on button may be recessed to prevent accidental activation. Pressing the emergency power-on button may cause all power cards to power-on. Power-on refers to a power module entering a state in which it provides power to the 6U card beneath it. The emergency power-on may be a momentary event, not a maintained state, i.e., if new power modules are added after an emergency power-on event, they will not be powered-on unless the emergency power-on button is pressed again or the managing issue has been resolved. Additionally, the alarm module may support holdup capacitors, and the holdup capacitors may be isolated from the input by a soft-start circuit, limiting inrush current to less than 200% of maximum steady-state input current. The holdup time may be at least 30 ms. The capacitors may also include a bleeder circuit designed to lower the voltage level on capacitors to a safe level within two seconds of the removal of power from the module. Dry contact outputs may be rated for a maximum of 1 A at the 48V input range (0-71V). Furthermore, each alarm module may provide I/O connectivity for each of the redundant manager modules. Also, each alarm module may include two female gender DB9 serial connectors and two RJ45 Ethernet connectors. Each Ethernet port may include green link and green activity LEDs and support NIC pinout. The serial connectors may be labeled “SER1” and “SER21” to correspond to serial connections to manager cards in slots 1 and 21. The Ethernet connectors may be labeled “ETH1” and “ETH21” to correspond to Ethernet connections to manager cards in slots 1 and 21. Each alarm module may include two connectors for IPMI connectivity to external expansion boxes or alarm panels. The IPMI connectors may be labeled “IPMI-A” and “IPMI-B.” Each alarm module may include one female gender serial connector for dry-contact alarming. The alarm connector may include the 3 dry contact outputs, with a normally-open and normally-closed pole for each output. The alarm connector may include two reset inputs, one for each manager. Pulling the reset line to ground may reset the manager. The alarm connector may also include two general purpose I/O lines to the local microcontroller. The alarm connector may include digital ground and a +5V signal, current limited to 100 mA. Each alarm connector may be labeled “ALARM.” Each alarm may include dry contact relays for each connector. Each alarm module may provide ten (10) red “REPL” LEDs for each of the rear transition card slots beneath it to indicate whether the cards in these slots need to be replaced. The alarm modules may provide the replace LEDs for slots 1-10 and 12-21. The replace LED indication for slot 11 is provided on the single slot divider panel between the alarm modules. Each alarm may provide 1 additional red “REPL” LED for slot 11. The LED indication on the slot 11 divider panel between alarm modules may be an LED or a light-pipe from an adjacent alarm. LEDs may physically align with each slot. Each alarm may support a lamp-test mode for all alarm LEDs. Each alarm module may also provide a red “REPLACE MODULE” LED to indicate whether the alarm module itself needs to be replaced.

In accordance with another embodiment of the present invention, the chassis may include an ESD panel. The ESD panel may reside, for example, in the slot 11 position between the alarm modules. In addition to providing an ESD jack for craftsperson grounding, this panel provides the replace LED for slot 11. By using this single slot panel for slot 11, a single alarm module may be used in either side of the chassis. The rear ESD panel may reside in slot 11 between alarm modules, be a swappable module and provide an ESD jack. The ESD jack may use a banana connector with a metallic shroud. The ESD jack may be labeled “ESD.” The rear ESD panel may provide a red “REPL” LED indicating whether the rear transition card in slot 11 needs to be replaced. The replace LED may be aligned with the RTM (Rear Transition Module) replace LED's on the alarm module.

The chassis may also include a console module, according to another embodiment of the present invention. The console module may be located on the rear of the chassis; the module routes serial via the midplane to the power modules where it can be relayed over IPMI to the manager. The benefit of the console approach is that regardless of what pins are used for serial by the blade, as long as the blade supports an external serial connection, the management system will be able to provide access to it from the manager modules. This module also provides rear I/O connectors for each of the manager modules as well as slot numbers corresponding to each rear transition card cage slot. The console may provide a slot number for each rear transition card cage slot. The slot numbering may physically align with the rear transition card cage slots. The console may provide one serial connector for each slot number/rear transition card cage slot. The serial connector may be a female DB9 connector with DCE pinout. The console may be replaceable.

It will be apparent to those skilled in the art that various modifications and variations can be made in the described embodiments of the present invention without departing from the spirit or scope of the invention. Thus, it is intended that the present invention cover the modifications and variations of this invention provided they come within the scope of the appended claims and their equivalents.

1. A method of providing power to a telecom/datacom system, the system having a plurality of slots for housing a plurality of types of electronic circuit boards and a plurality of power supplies, the method comprising:
forming independently powered slots by coupling each slot adapted to receive a power supply to a slot adapted to receive any of a plurality of types of electronic circuit boards;
housing one power supply in a slot adapted to receive a power supply;
housing one electronic circuit board of the plurality of types in a slot coupled to a slot housing the power supply; and
supplying power to the one electronic circuit board of the at plurality of types from the power supply via the coupled slots.

2. An independently powered slots architecture comprising:
housing for a plurality of types of electronic circuit boards and a plurality of power supplies, the housing having independently powered slots formed by coupling each slot adapted to receive a power supply to a different slot adapted to receive any of a plurality of types of electronic circuit boards; and
power input connectors for providing power from a central power supply to the power supply via the slots adapted to receive a power supply.

3. An independently powered slots architecture for use in a telecom/datacom system, comprising:
a chassis having a front side and a rear side;
a card cage for housing a plurality of types of electronic circuit boards and a plurality of power supplies, the card cage having independently powered slots formed by coupling each slot adapted to receive a power supply to a different slot adapted to receive any of a plurality of types of electronic circuit board;
a cooling module; and
at least one independent power supply connected via the coupled slots to an I/O card to provide power to the I/O card.

4. The architecture according to claim 3, wherein the power provided to the I/O card is provided via a midplane using power pins.

5. The architecture according to claim 3, wherein the power provided to the I/O card is provided via a cable from the independent power supply.

7. The architecture according to claim 3, further comprising a manager module.

8. The architecture according to claim 7, wherein the manager module itself provides power to the I/O card via the coupled slots.

9. The architecture according to claim 8, wherein the manager module provides connections to the at least one power supply in the chassis.

10. The architecture according to claim 3, further comprises an alarm module.

11. The architecture according to claim 10, wherein the alarm module includes I/O connectivity for each power supply.

12. The architecture according to claim 11, wherein the alarm module further includes at least one LED.

13. A method for supplying power in telecom/datacom systems, comprising:
connecting dual power inputs from a central power supply to independent power supplies; and
connecting each of the independent power supplies to a corresponding I/O card, and utilizing the power supply as the sole power source to the I/O card.
